(19) United States
(12) Patent Application Publication
(10) Pub. No.: US 2017/0079476 A1
(43) Pub. Date: Mar. 23, 2017

(54) FOOD STORAGE CONTAINER WITH REMOVABLE PORTION

(71) Applicant: Carter-Hoffmann LLC, Mundelein, IL (US)

(72) Inventors: Robert C. Fortmann, Grayslake, IL (US); Frank G. Marolda, Vernon Hills, IL (US)

(73) Assignee: Carter-Hoffmann LLC, Mundelein, IL (US)

(21) Appl. No.: 15/266,712

(22) Filed: Sep. 15, 2016

Related U.S. Application Data
(60) Provisional application No. 62/330,438, filed on May 2, 2016.
(60) Provisional application No. 62/220,698, filed on Sep. 18, 2015.

(51) Int. Cl. A47J 39/00; B65D 88/74; B65D 90/00; B65D 88/26

(52) U.S. Cl. CPC A47J 39/006; A47J 39/003; B65D 88/26; B65D 88/74; B65D 90/008

(57) ABSTRACT

A food storage container is provided. The container includes a housing with a bottom, a first side wall, and a second side wall fixed to the first side wall that defines a food storage volume therewithin. The first side wall extends from a first end portion that includes a first peg that extends therefrom in a direction parallel with a plane through the first side wall. A third side wall is removably mounted to the first peg, wherein when mounted to the first peg, the third side wall establishes a barrier of the food storage volume different than barriers of the food storage volume provided by the bottom, the first side wall, and the second side wall. When the third side wall is removed from the first peg, the food storage volume may be accessed through a void left by the removal of the third side wall.

### CROSS-REFERENCE TO RELATED APPLICATIONS

This application claims priority from U.S. Provisional Application No. 62/220,698, filed Sep. 18, 2015 and from U.S. Provisional Application No. 62/330,438, filed May 2, 2016, the entirety of which are each hereby fully incorporated by reference herein.

### BACKGROUND

This disclosure relates to equipment used in a commercial kitchen to cook and store prepared food prior to presentation to the customer.

### BRIEF SUMMARY

A first representative embodiment of the disclosure is provided. The embodiment includes a food storage container. The food storage container includes a housing comprising a bottom, a first side wall, and a second side wall fixed to the first side wall, wherein the combination of the bottom and the first and second walls defines a food storage volume therewithin. The first side wall extends from a first end portion, wherein the first end portion includes a first peg that extends therefrom in a direction that is parallel with a plane through the first side wall. A third side wall is removably mounted to the first peg, wherein when mounted to the first peg, the third side wall establishes a barrier of the food storage volume different than barriers of the food storage volume provided by the bottom, the first side wall, and the second side wall. When the third side wall is removed from the first peg, the food storage volume may be accessed through a void left by the removal of the third side wall.

Another representative embodiment of the disclosure is provided. The embodiment provides a food storage and metered distribution system. The system includes a housing comprising an open top, and opposite first and second side walls that define a portion of the open top and an internal volume therebetween, housing further comprises a removable front barrier that when positioned establishes a portion of the internal volume and when removed allows for access into the internal volume. A hopper is disposed within the housing comprising a storage volume and an open bottom. A food distribution and metering system is disposed within the housing comprising a wheel disposed below the open bottom of the hopper and a receiving trough disposed below the wheel. The hopper is slidably mounted upon upper portions of the first and second side walls such that the hopper can slide with respect to the first and second side walls when the removable front barrier is removed to an extended position and returned to a normal position where the hopper is disposed such that its open bottom is above the wheel.

Advantages of the disclosed devices will become more apparent to those skilled in the art from the following description of embodiments that have been shown and described by way of illustration. As will be realized, other and different embodiments are contemplated, and the disclosed details are capable of modification in various respects. Accordingly, the drawings and description are to be regarded as illustrative in nature and not as restrictive.

### BRIEF DESCRIPTION OF THE DRAWINGS

FIG. 1 is a perspective view of a food storage container.

FIG. 1 a is a detail view of detail A of FIG. 1 depicting the engagement of the peg and the aperture of the food storage container.

FIG. 2 is the view of FIG. 1 with an end wall removed to form a void.

FIG. 3 is the view of FIG. 1 with the tray removed from the food storage volume.

FIG. 4 is a detail view of a peg that is usable with the food storage container of FIG. 1.

FIG. 5 is another perspective view of the food storage container schematically showing a heating element and ventilation fan that may be provided with the container.

FIG. 6 is a perspective view of another food storage container.

FIG. 7 is the view of FIG. 6 with the first door to the housing opened.

FIG. 8 is the view of FIG. 6 with portions of the housing removed to depict the hopper and the metering and dispensing mechanism, with the dispensing mechanism disposed in a receiving position.

FIG. 9 is the view of FIG. 8, with the dispensing mechanism is disposed in a dispensing position.

FIG. 10 is a cross-sectional view of the food storage container of FIG. 6.

FIG. 10a is another cross-sectional view of the food storage container of FIG. 6.

FIG. 11 is a detail view of the view of FIG. 8.

FIG. 12 is the view of FIG. 11 with the hopper slid into the extended position.

FIG. 13 is a detail view of FIG. 7 depicting the shroud is in the removed position (when the door removed).

FIG. 14 is a detail front sectional view of the hopper and the wheel.

FIG. 15 is a perspective view of an alternate shroud usable with the food storage container of FIG. 6.

FIG. 16 is a side view of FIG. 15 showing the valve of the shroud in a closed position.

FIG. 17 is the view of FIG. 16 showing the valve in an open position.

### DETAILED DESCRIPTION OF THE DRAWINGS AND THE PRESENTLY PREFERRED EMBODIMENTS

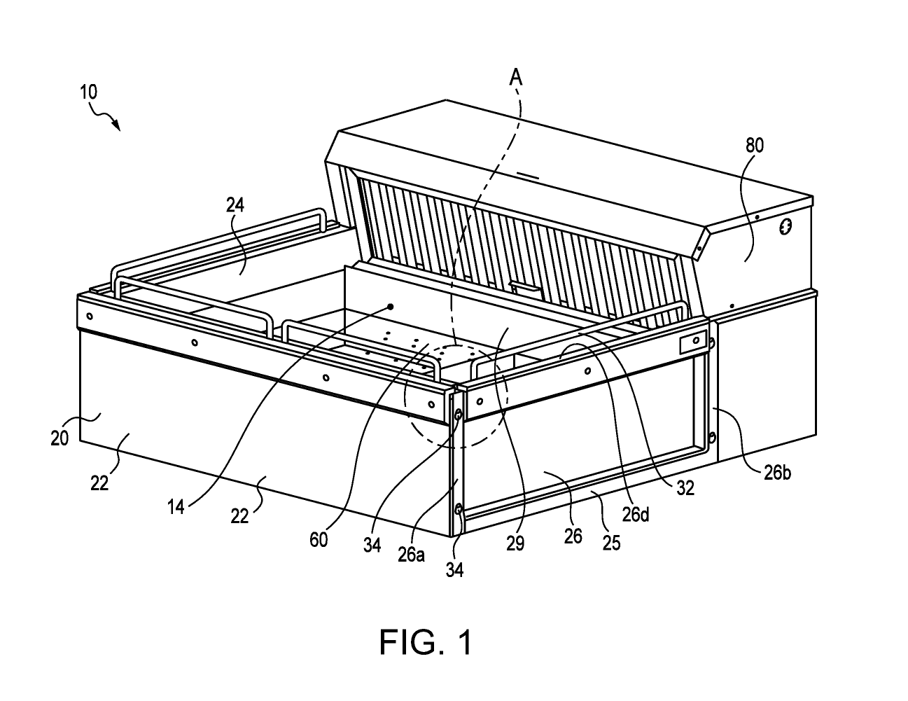

Turning now to FIGS. 1-5, a food storage container 10 is provided. The food storage container 10 may be an apparatus that is configured to hold previously cooked or prepared food products for a time period until the food product is served to the customer or further prepared. For example, the food storage container 10 may be useful to store food such as French fries, chicken fingers, or other items that are cooked in a deep fat fryer, or in other (or the same) embodiments, the food storage container 10 may be useful to store foods (such as vegetables, proteins, breads, and the like) that were cooked or baked in an oven before they are ultimately served to the customer. In some embodiments, the food storage container 10 may include a heat source and/or a forced air system to maintain the temperature and the moisture of the food product as it is being held in the container 10.

The food storage container 10 may be configured as a standalone component within a kitchen, or in some embodiments, the container 10 may be disposed next to various food cooking and preparation equipment that is used to cook and prepare the food product before it is placed into the container 10. For example, the food storage container 10 may be within a food preparation line that might include an oven, a fryer, a rethermalizer, or other components. Often the space within a kitchen and associated with a food preparation line is tight, with several food service professionals working within a small area in the food preparation line. The present disclosure may be beneficial to allow for an easy removal of a food tray 60 and drip pan 70 (discussed below) from the food storage container 10 for cleaning or other purposes while maintaining the compactness of the container 10 and the tight spacing of the container 10 and other equipment within the food preparation line.

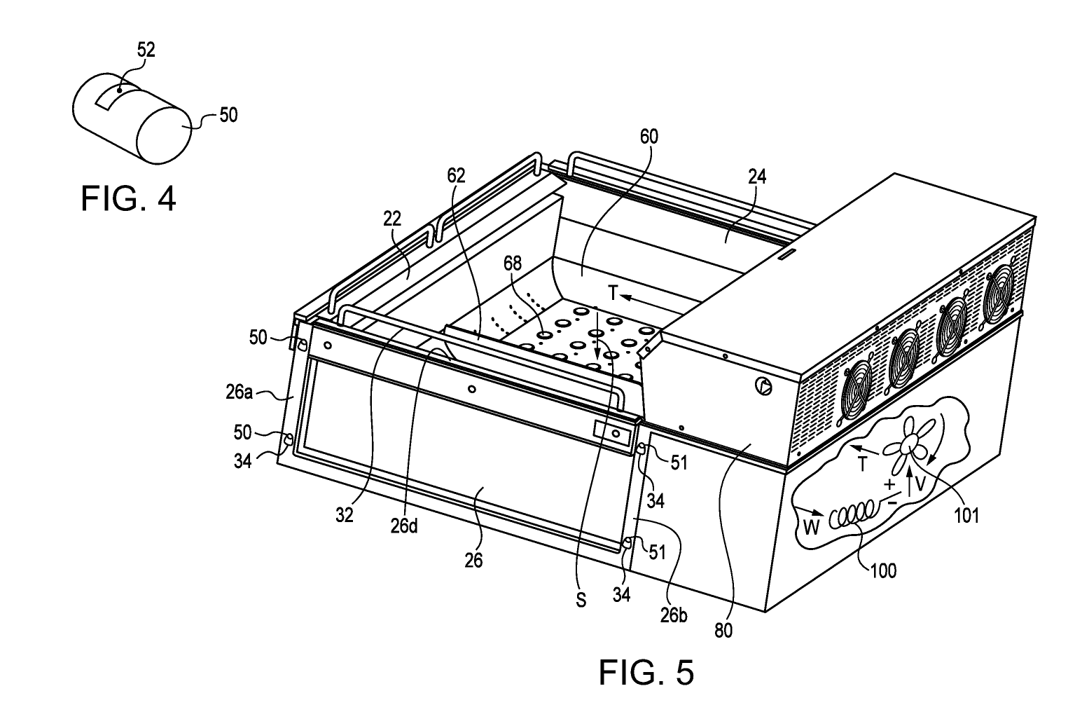

The container 10 may include a housing 20 that includes a plurality of walls and a bottom 28 that collectively define an open food storage volume 14 therewithin. The food storage volume 14 may be defined a plurality of rigid walls, such as first and second side walls 22, 24, and a rear wall 29 which may be a portion of a compartment 80 that houses the electrical and mechanical components associated with the container 10, such as a heating element 100 (electric heater or gas burner) and a fan 101 or other air handling structure each shown schematically in FIG. 5. The open food storage volume 14 may be further defined by a removable wall 26 that can be fixed to the housing 20, such as with a connection to a first wall 22 and the rear wall 29 with the removable wall 26 forming a side wall of the housing 20. Alternatively, the removable wall 26 may be connected to two side walls when the removable wall 26 forms a front wall of the housing 20. The removable wall 26, when installed forms a barrier of the food storage volume 14 that is different from barriers that are provided by the bottom 28, the first side wall 22, the second side wall 24, and the rear wall 29 (when provided).

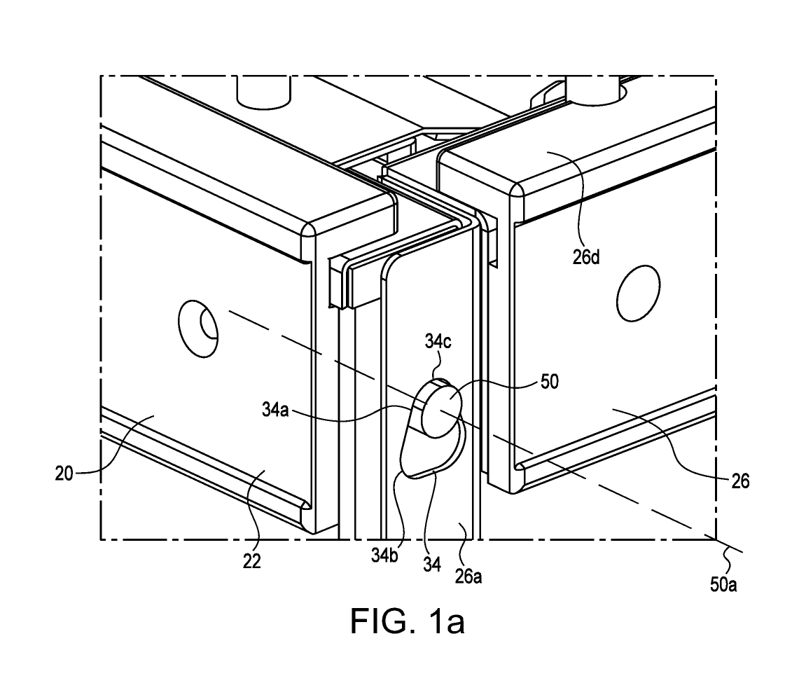

The removable wall, such as the side wall 26 depicted in the figures, may be fixed with respect to the remainder of the housing 20 such that it is rigidly mounted thereon, but can be easily removed by the user without any tools. When the removable wall 26 is removed a void 18 may be established that communicates with the food storage volume 14, and which allows components to be slid into and out of the food storage volume 14 (through the void 18) in the directions X (out of the food storage volume 14) and Z (into the food storage volume 14) as schematically shown in FIG. 2.

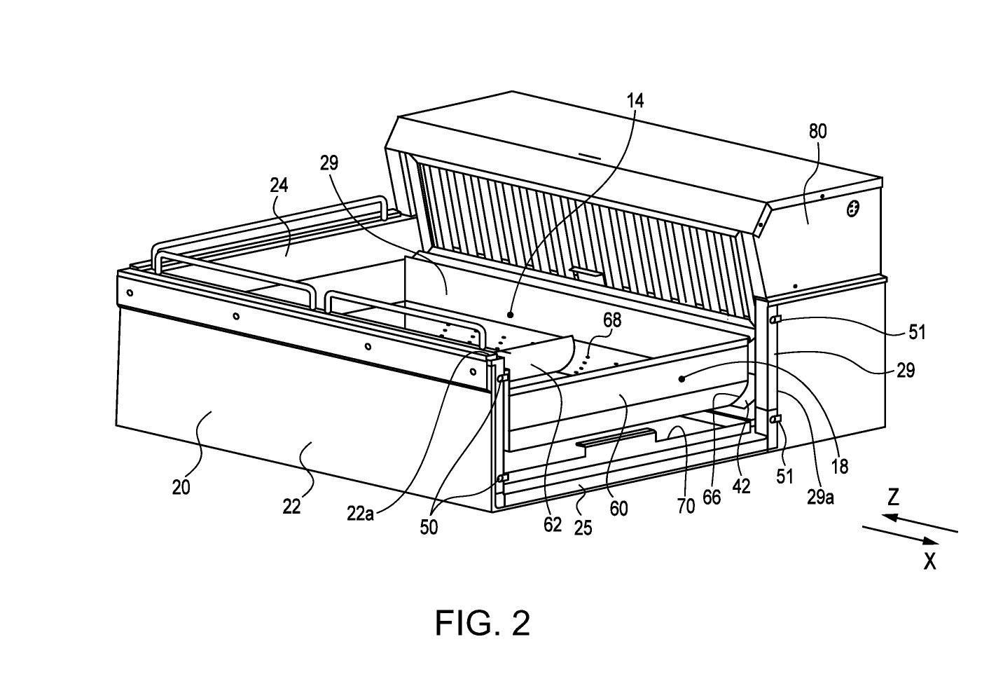

In some embodiments, one or two of the fixed walls, e.g. the front wall 22 and the rear wall 29 (or an outer wall that is a portion of the housing 20 or the working chamber 80, discussed below), may support a track 42 along their length, such as their entire length, or a portion of the their length less than their entire length (e.g. 50% of the length, 75%, 80%, 90%, or the like). The track 42 may support a corresponding component 66 that is supported by a food tray 60, such as a track, rollers, wheels, or other structure that is disposed upon a food tray 60 that may be disposed within the food storage volume 14, such that the tray 60 is supported upon and rides upon the track 42. The component 66 may slide upon the track (such as with opposed low friction surfaces on the track 42 and the component 66), or in other embodiments, the component 66 may be a wheel that rolls upon the track 42, but in either construction the tray 60 slides within the food storage volume 14 and through the void 18 (when the removable wall 26 is removed). As best understood with review of FIGS. 2 and 3, the engagement between components 66 of the food tray 60 and the track 42 allow for easy removal and reinsertion of the food tray 60 through the void 18 with the removable wall 26 removed from the housing 20.

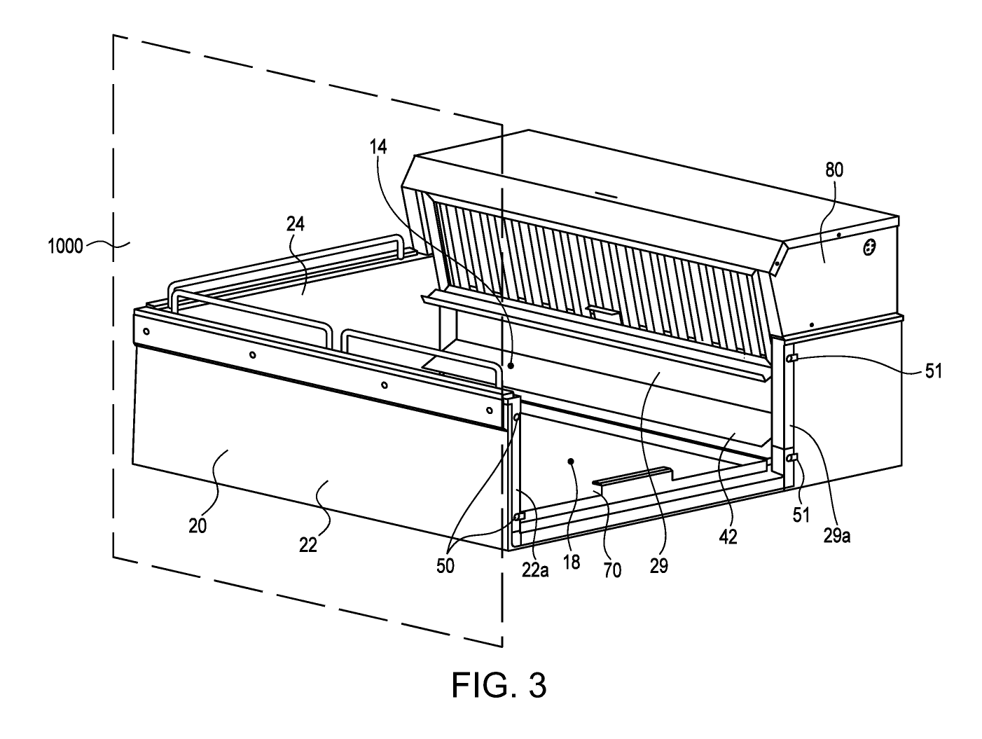

In some embodiments, the fixed walls, such as the front wall 22 and the rear 29 may include pegs 50, 51 (or other suitable structures as discussed elsewhere herein) that extend from end faces of the walls 22a, 29a, with the pegs 50, 51 extending in parallel to a plane 1000 that extends through the length of the front wall 22 (FIG. 3) (or in embodiments wherein the front wall 22 is removable, the pegs 50, 51 extend in parallel to a plane through the wall from which they extend). In some embodiments, four pegs 50, 51 may be provided (such as two sets of two pegs on each wall 22, 29). The pegs 50, 51 may be cylindrical, or another shape, such as rectangular, hexagonal, or an arcuate or planar shape that would be understood by one of ordinary skill in the art to readily slide into and out of an aperture in a wall 26. The term “peg” will be used herein for the sake of brevity, but one of ordinary skill in the art will understand that the peg may be a cylindrical shape or other shapes as discussed herein. As shown in FIG. 4, the pegs 50, 51 may be cylindrical, but include a slot 52 disposed therein with receives a portion of the removable wall 26 when connected thereto. In some embodiments, the pegs 50, 51 may include a uniform cross-section along their length, while in other embodiments the pegs 50, 51 may include a larger cross-section at the tip than the body of the peg.

In some embodiments, the removable wall 26 may include a plurality of apertures 34 that are disposed thereon in locations that are configured to receive each of the plurality of pegs 50, 51 therethrough. In some embodiments, the removable wall 26 may include two opposite end portions 26a, 26b with each end portion including two apertures 34 disposed therethrough. As best shown in FIG. 1, the apertures 34 are configured to allow the pegs 50, 51 to extend therein, or in some embodiments therethrough (i.e. a tip or more of the peg 50, 51 extends out of the aperture 34).

In some embodiments, the apertures 34 may be round with a diameter just larger than the diameter of the peg 50, 51 that is in registry with the respective aperture 34. In these embodiments, the removable wall 26 is slidably mounted upon the pegs 50, 51. In other embodiments, the apertures 34 may include an upper portion 34a with an arcuate inner edge (such as round) with an opening width just larger than a diameter of the respective peg 50, 51 and the apertures 34 may additionally include a lower, wider, portion 34b with a width that is significantly larger than a diameter of the respective peg 50, 51, such as 25% larger, 50% larger, 100% larger, or another ratio. The apertures 34 are sized and shaped and positioned upon the removable wall 26 such that the removable wall 26 initially engages the pegs 50, 51 (specifically with the pegs 50, 51 extending through the respective apertures 34) with the pegs 50, 51 extending through the lower portion 34b, and then when the removable wall 26 is fully assembled, the removable wall 26 is lowered until the pegs 50, 51 extend through the upper portion 34a of each aperture 34.

In some embodiments, as shown in FIG. 4, one, some or all of the pegs 50, 51 may include a slot 52 disposed upon an upper facing side surface of each peg 50, 51. The slot 52, when provided, is a recess within the body of the peg and is configured to receive a portion of the removable wall 26, and specifically a portion of the removable wall 26 that is formed above the upper edge 34c that defines the upper portion 34a of the aperture 34, such that when engaged the removable wall 26 cannot be directly pulled away from the housing in the direction parallel to the longitudinal axis 50a of the pegs 50, 51a. In embodiments with slots 52 defined in the pegs 50, 51, the removable wall 26 can be removed by first lifting the removable wall 26 upward with respect to the housing 20 (and the pegs 50, 51) to remove engagement of the upper edge 34c of the aperture 34 with the slots 52. In some embodiments, it may be preferred to lift the removable wall 26 even further with respect to the pegs 50, 51 until the pegs reside within the wider lower portion 34b of the apertures 34 to allow the removable wall 26 to easily be pulled away from the pegs 50, 51 and the housing 20.

As discussed above, a food tray 60 may be provided within the food storage volume 14. The food tray 60 may include one or several compartments 62 for holding food products (such as precooked food) therein until it is removed for further preparation or for presentation to the customer. The food tray 60 may include a plurality of holes 68 in the walls (bottom and or side walls) that allow for drainage of liquids from the food product (potentially into a pan 70 below the food tray, when provided). The holes 68 may additionally allow for air flow therethrough that may be directed to the heat source 100 and the fan 101 (in the direction W, FIG. 5) (potentially located within a working chamber 80) to allow for a loop of air through the housing 20, which may return toward the food tray 60 in the direction T, and potentially again past the food disposed within the food tray in the direction S, wherein the air then flows through the holes 68 and again returns to the working chamber 80 in the direction W.

In some embodiments, the removable wall 26 may include a bar 32 that is disposed above the upper surface 26d of the wall 26. The bar 32 may serve various functions, including providing the user with a structure to hold to allow the removable wall 26 to be lifted vertically upward with respect to the housing 20 and specifically the pegs 50, 51 that extend through the apertures 34 in the wall 26, such that when the wall 26 is lifted the pegs 50, 51 extend into the lower (wider) portion 34b of the plurality of apertures 34 to allow the wall 26 to be pulled away from the housing 20 in a direction parallel to the longitudinal axes through the pegs 50, 51. In embodiments where the pegs 50, 51 include slots 52, the upward lifting of the wall 26 allows the wall 26 (and specifically the surface 34c above the upper portion 34a of the aperture 34) to be removed from the slot 52. The bar 32 may define an air gap between the bar 32 and the upper surface 26d of the wall 26, which (due to possible air flow therethrough) may provide ambient cooling to the bar 32 to limit the surface temperature of the bar 32 when being manipulated by the user for removal of the removable wall 26 from the housing 20. The bar 32 may also provide a barrier to prevent food product from falling out of the container 10, and specifically the tray 60 when being manipulated by the food service professional. In some embodiments, the fixed walls 22, 24 may also have similar bars.

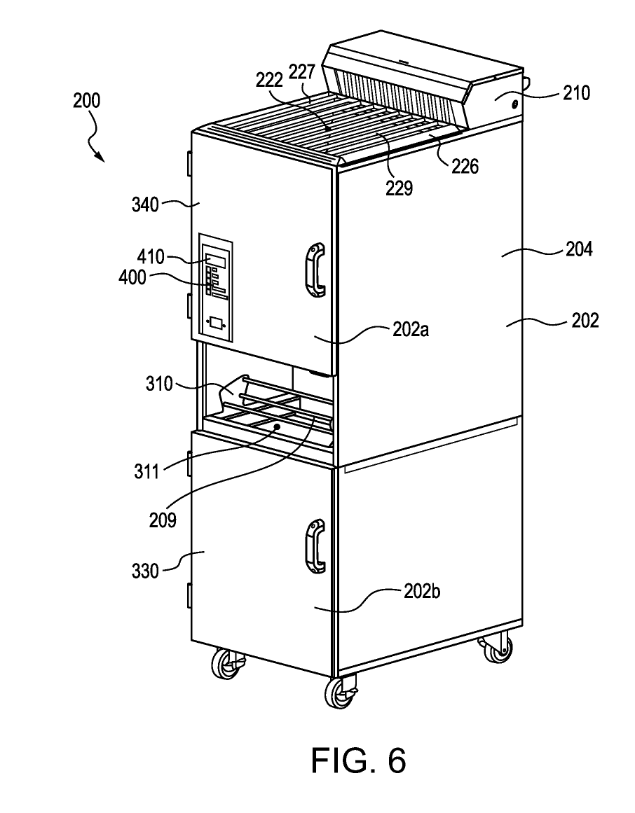

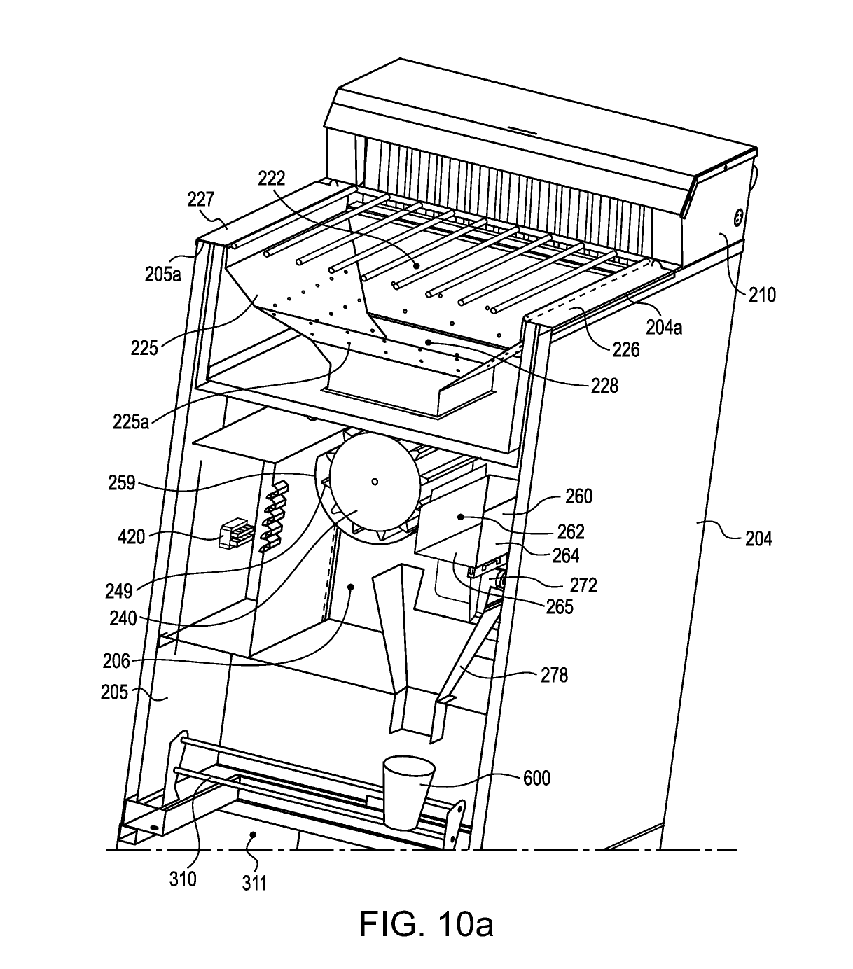

Turning now to FIGS. 6-14, a food storage and metered distribution system 200 is provided. The system is configured to receive a quantity of food product, such as discrete items of food product (such as French fries, onion rings, chicken nuggets, and the like) therein. The system includes a container 200 that is configured to receive and retain the discrete items of food product and store them in a temperature controlled environment (such as a heated or warmed condition) in preparation for metered disposal into individual containers for saleable food product 600 that are disposed within the container 200. The container, upon receipt of an input that a user desires to fill an individual container 400, operates a metered distribution system 500 to direct a quantity of food product from a storage hopper 220 and ultimately to the individual container 600. In a representative embodiment, the metered distribution system 500 is configured to direct a specific quantity of food product to the individual container 600 that is sized dependent upon the volume of the individual container 600 selected by the user. In a representative embodiment, the metered distribution system 500 is configured to direct a plurality of different specific quantities of the food product based upon a plurality of different sized food containers 600 based upon the selection of the specific size of container by the user.

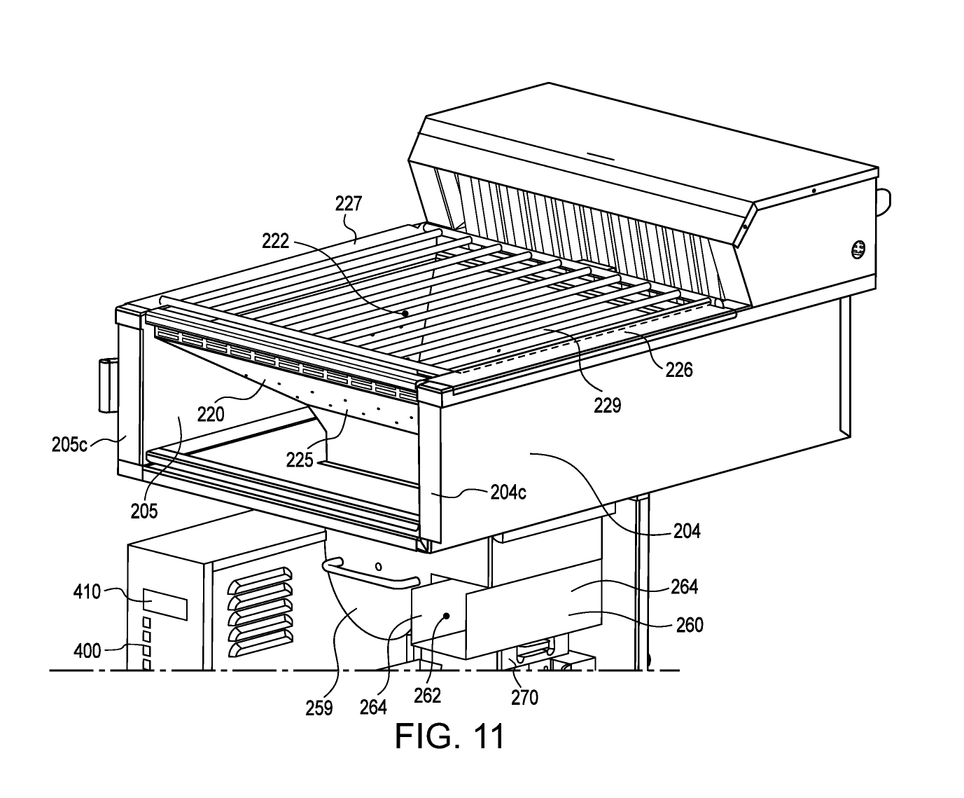

The container 200 includes a housing 202 that includes side walls and an open top 203 (FIG. 12). The side walls include opposed right and left side walls 204, 205, and a rear wall 206 that bridges the side walls, each of which partially define an internal volume 208. Each of the right and left side walls 204, 205 include top edges 204a, 205a that establish the top surface of housing and are each exposed upon the top of the housing. Each of the right and left side walls 204, 205 include vertical front edges 204c, 205c that run for at least a portion of the height of the housing, and in some embodiments the entire height of the housing. The left and right side walls 204, 205 may be a single sheet of material (such as stainless steel, other metal, or plastic) while in some embodiments the left and right side walls 204, 205 may include multiple pieces that are arranged in parallel and/or in a sandwiched fashion, such as to provide strength to the housing, to insulate the internal volume of the housing, for sound dampening through the walls of the housing 202 and/or for different purposes. The term “side wall” is defined to include walls of the housing that are formed with any of this structure discussed above. In some embodiments, the side walls 204, 205 may define the inner and/or outer surface of the housing 202, while in other embodiments other portions may define one or both of the inner or outer surfaces of the housing 202.

The housing may further include a rear wall 206, that in conjunction with the right and left walls 204, 205, establishes the internal volume 208. The rear wall 206 may be formed as the right and left walls, discussed above, or in a different manner. The housing may also include one or more bottom walls (not shown, but similar in structure to the right, left, and rear walls. In some embodiments, the housing may include an upper cabinet 202a, which includes an upper interior volume 208, which encloses the hopper 220 and the food distribution and metering system (discussed below), and a lower cabinet 202b, which includes space for storage as well as a bin to receive excess food that is not received within a food container 600 supported upon a rack 310 (discussed below). The housing may include a wall 209 between the upper cabinet 202a and the lower cabinet 202b. the wall 209 may include an aperture 311 that allows discrete food items that fall from the metered distribution system 500, but are not captured within a container 600 to fall into the lower cabinet 202, and when provided fall into a trash can within the lower cabinet. The lower cabinet 202b may be selectively accessible via a removable panel 330, such as a door that is hingedly mounted to a side edge of one of the right or left walls 204, 205.

The housing 200 supports a hopper 220 which is provided to retain a quantity of food product within a holding portion 223. The holding portion 223 extends from the open top 222 of the housing 200 such that the food product is poured or placed into the holding portion 223 through the open top 222. In some embodiments, a grate 229 is disposed across the open top 222 of the hopper (and the open top of the housing 202) and is configured to prevent a user's hand or other foreign object to be placed into the hopper 220, such as to prevent contact with the hot sides walls 225 of the hopper 220 during operation and the rotatable wheel 240 (discussed below) disposed below the hopper 220.

As shown in the figures, in some embodiments, the hopper 220 may be formed as a truncated pyramid, such that the various side walls 225 extend toward each other. This configuration of the hopper 220 urges discrete food items added to the hopper to funnel toward a center bottom opening 228 of the hopper 220, which defines the bottom of the hopper 220.

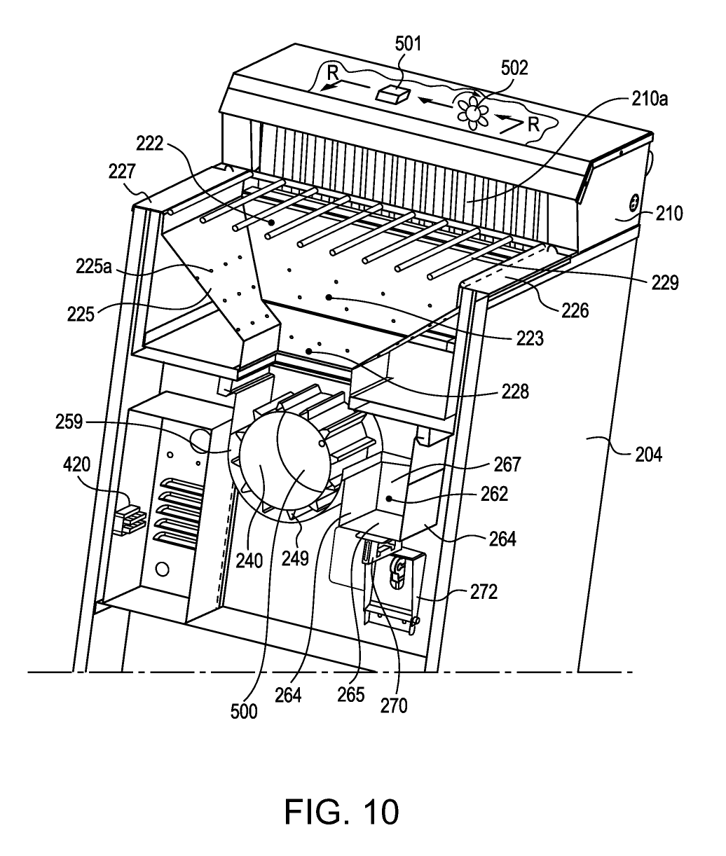

In some embodiments, the hopper 220 may receive heat from a heat source in order to maintain a temperature of the food product within the hopper 220 at an elevated temperature above the ambient. The heat source may include heaters (not shown, but similar to heater 501 shown schematically in FIG. 10) that are disposed proximate to the walls 225 of the hopper to radiate and/or conduct heat into the holding portion of the hopper, and/or in some embodiments, the hopper may receive a flow of heated air into the holding portion that is configured to flow past the food product therewith. The heated air may be provided by way of a fan 502 (shown schematically in FIG. 10) that is located within a mechanical compartment 210, and the air flows in the directions R through holes in the walls of the hopper 220. The fan 502 may take suction from just above the opening into the hopper 220 such that the heated air is cycled continuously through the hopper 220 for thermal efficiency reasons. In some embodiments, the mechanical compartment 210 may include one or more heaters 501 that are disposed within the flow path R (such as downstream of the fan) so that heat is added to the air flowing through the path R within the mechanical compartment. In some embodiments, air flows through the fan 502, through the heater 501, and then to the outer surface of the side walls 225 of the hopper 220. Air then flows through the plurality of apertures 225a in the side walls and into the holding portion 223 of the hopper, where the air interacts with the food product disposed within the hopper 220. An inlet into the mechanical compartment 210 is disposed proximate to the open top 222 of the hopper (though the grate 210a in the mechanical compartment) that draws air therethrough due to the suction created at the inlet of the fan 502 during operation.

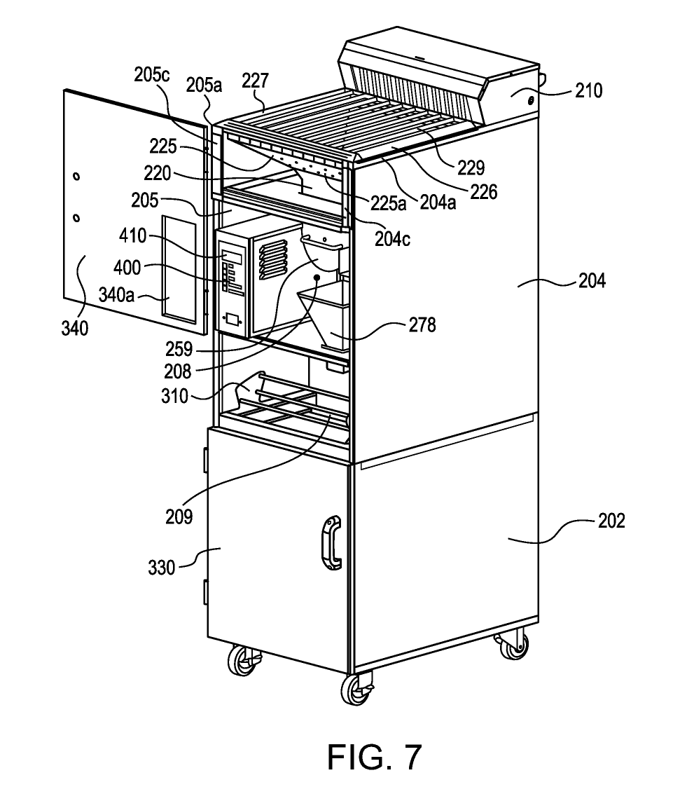

The housing 202 may further include a removable front barrier 340 that when positioned in a normal (in some embodiments closed) position, establishes a portion of the internal volume 208 of the housing, and when removed allows access to the internal volume 208. In some embodiments shown in FIGS. 6-7, the front barrier 340 may be a door that is hingedly attached to a front side edge 204c, 205c of one of the first or second side walls 204, 205 and when in a closed position contacts or closely engages the other front side edge. In other embodiments, the front barrier may be removable wall, similar to the removable wall 26 discussed above and may be removably attached to the housing in the same or a similar manner as the attachment of the removable wall 26 discussed above. In some embodiments, the front barrier 340 includes an aperture 340a that allows an input 400 and a display 410 (discussed below, when provided) to be accessible to the user from the front of the housing 202 when the front barrier 340 is in the normal closed position.

In some embodiments, the hopper 220 may rest upon and be slidably mounted to one or both of the right and left walls 204, 205, and in some embodiments the hopper 220 may be slidably mounted upon one or both of the top edges 204a, 205a of the right and left side walls 204, 205. The hopper 220 may include first and/or second flanges 226, 227 that each extend outward from the hopper, such that the first flange 226 (when provided) engages the top edge 204a of the right wall and the second flange 227 (when provided) engages the top edge 205a of the left wall 205. In other embodiments, the right and left walls 204, 205 may include tracks, that may be formed upon or supported by the respective wall, which receive the respective first and second flanges 226, 227 of the hopper 200. The tracks may normally be proximate to the open top of the housing, but may alternatively be located a distance below the open top. One of ordinary skill in the art with a thorough review of this specification and figures will understand that the flanges upon the hopper 220 and the respective edges or tracks on the housing 202 may be located at any convenient location upon the hopper and the housing that would allow for relative sliding of the hopper 220 with respect to the housing 202, as discussed in more detail below, as is necessitated or optimized by routine design considerations such as the size of the various components of the housing, hopper, and food distribution and metering system (discussed below) as well as other bases. Any specific location for the components that allow for sliding support of the hopper 220 within the housing and sliding with respect to the housing are specifically contemplated with respect to this specification.

The hopper 220 may be slidably mounted with respect to the housing 202 from a normal position (FIGS. 7, 9, 10) to an extended position (FIG. 12) wherein the hopper is transitioned away from the rear wall 206 and the mechanical compartment 210 upon the housing 202, and specifically to allow access to portions of the housing and the components of the food distribution and metering system for cleaning or maintenance. When the front barrier 340 (such as the door) is in the closed position (or installed) the hopper 220 is fixed in the normal position and is prevented from sliding, and when the front barrier 340 is removed (such as the door being opened), the hopper 220 is free to be slid to the extended position. In some embodiments, the hopper 220 is freely slid by pulling upon the hopper 220, which allows the first and second flanges 226, 227 to slide upon the housing 202. When the hopper is desired to be returned to the normal position, the hopper is pushed to allow the first and second flanges 226, 227 to slide upon the housing 202 in the opposite direction. In other embodiments, a lock may be provided that retains the hopper in the normal position, and in some embodiments a second lock may be provided to retain the hopper in the extended position. The locks may be any structure known in the art, such as a pin and pin hole that engage to lock the hopper in place, a bar that extends across the outer surface of the hopper and engages the housing to prevent hopper movement, or other locking structures that are known in the art. In some other embodiments, the track or the upper edges 204a, 205a of the side walls may include an upstanding member proximate to the front edge, to prevent the first and second flanges 226, 227 of the hopper from sliding therepast, which prevents the hopper 220 from sliding off of the housing 202. Similarly, the tracks upon the side walls 204, 205 that engage the flanges 226, 227 of the hopper may be configured to prevent the flanges from disengaging with the tracks to prevent the hopper from sliding out of the housing.

As mentioned above, a food distribution and metering system 500 is provided, which selectively urges food product, such as discrete pieces of food product, from the hopper 220 to individual containers for a food product that are disposed below the system, normally within a rack 310, discussed below. The system may include a wheel 240 that receives discrete food product from the hopper 220 and when rotating delivers food product to a receiving trough 260. The receiving trough 260 may be pivotably mounted to the housing 202 to selectively pivot such that the food product disposed therewithin falls due gravity to a food container 600 that is disposed in the rack 310 below the outlet of the receiving trough 260.

The wheel 280 is rotatably mounted to the housing 202 and is disposed below the center bottom opening 228 of the hopper such that discrete food items from the hopper 220 fall from through the center bottom opening 228 and onto the outer circumferential surface of the wheel. The wheel 240 may include a plurality of ribs or teeth 249 that extend radially outward from the outer circumferential surface of the wheel 240. In some embodiments, the wheel 240 may include 10, 11, 12, 13, 14 or another number of ribs, and in some embodiments, the ribs 249 may be aligned upon the wheel with a consistent spacing between neighboring ribs 249. The ribs 249 may have a constant cross-section along their length (i.e. between the opposite front and back sides of the wheel) and in some embodiments, the ribs may be triangular (either truncated triangular or actual triangular) while in other embodiments the ribs may be rectangular, arcuate, round, or other shapes that are known in the art. In some embodiments, the ribs 249 may be configured to allow a single, or a specified number of discrete food products onto the outer surface of the wheel 240 such it can be reliably determined how many discrete food products are delivered by rotation of the wheel 240 for a specific time. In one embodiment, the ribs 249 may be spaced apart such that one chicken nugget (in a normal orientation) can fit between each rib 249.

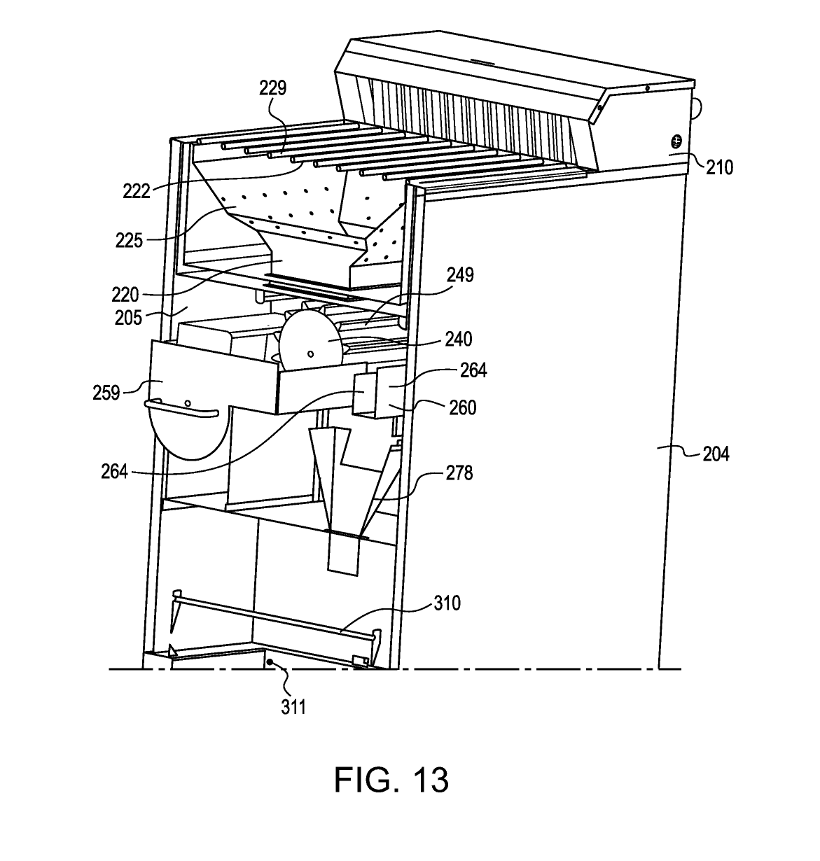

With reference to FIG. 14, the wheel 240 is mounted upon the housing 202 such that the wheel 240 receives discrete food product from the hopper, and particularly upon the outer surface of the wheel between neighboring ribs 249. As shown schematically in FIG. 14, the wheel 240 may be mounted such that the ribs 249, as they pass by when rotating, come very close to, but do not contact, a side edge 238 of center bottom opening 228, such that discrete food products (such as individual French Fries) that are disposed upon the outer circumference of the wheel 240 and below the height of the rib 249 (shown schematically as 700) can pass by the side edge 238, but the side edge blocks French Fries that may rest at a height above the height of the rib 249 (shown schematically as 701) when the wheel rotates in the direction Q (FIG. 14).

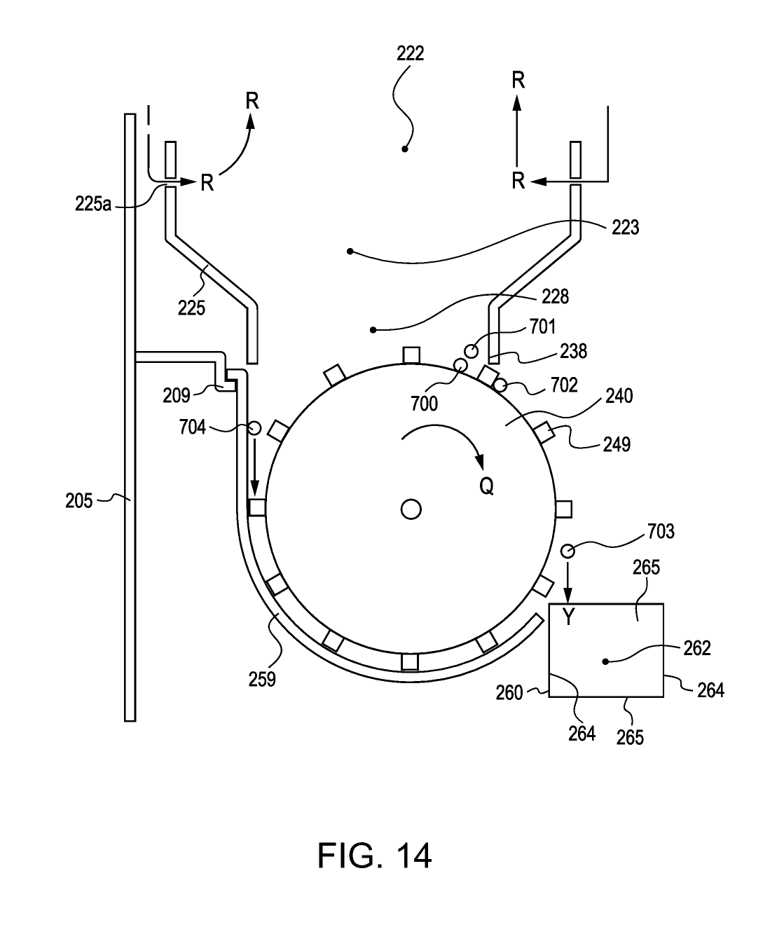

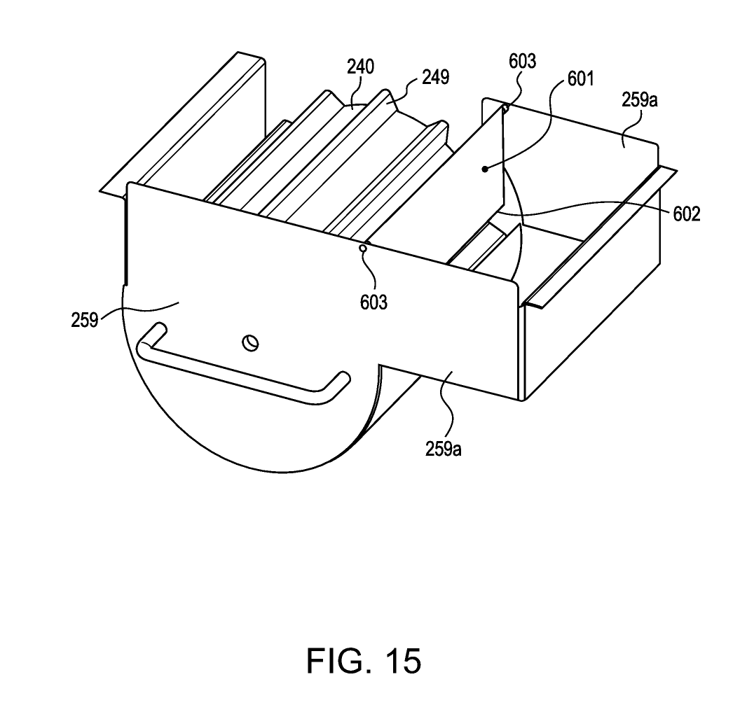

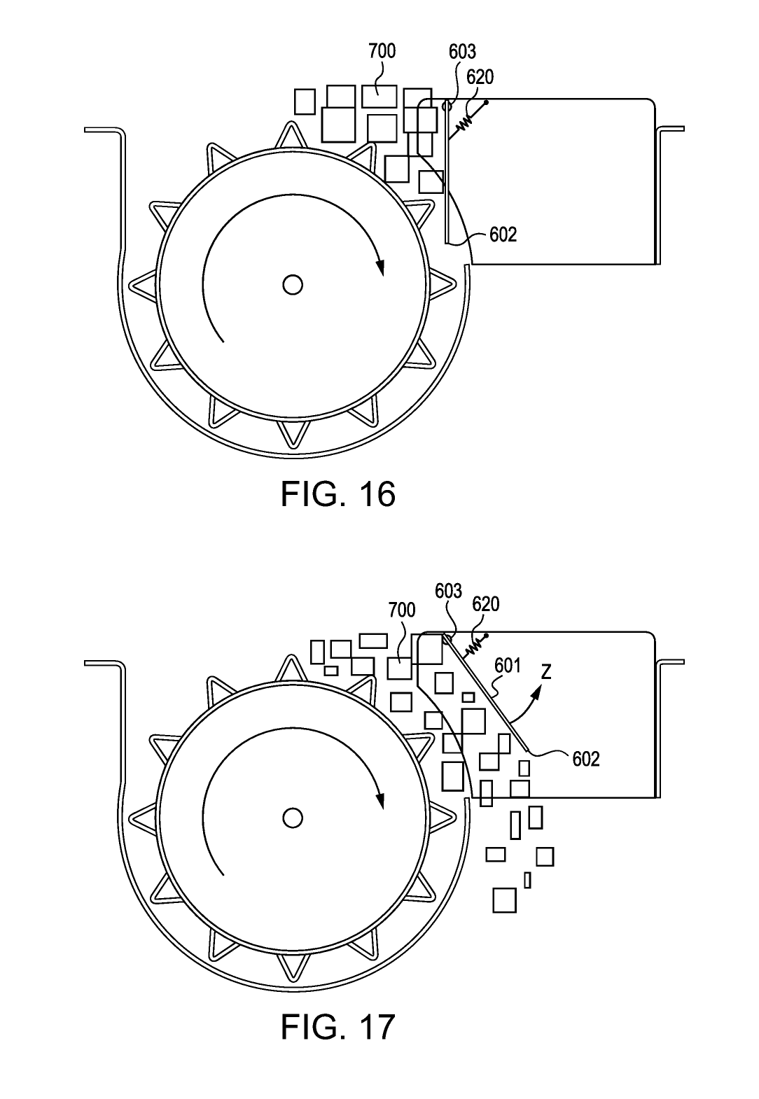

In other embodiments, the shroud 259 may support a valve 601, such as a pivotable door as depicted in FIGS. 15-17, which is disposed proximate to the wheel 240. The valve 601 blocks discrete food products 700 (shown schematically in FIGS. 16 and 17) from falling from the wheel 240 when in a closed position (FIG. 16) and can move to an open position (FIG. 17) to allow discrete food products 700 to fall from the wheel 240, and toward the receiving trough 260 (discussed below).

In embodiments depicted in FIGS. 15-17, the valve 601 may be a pivotably mounted to the trough 259, such as to one or both side walls 259a of the trough 259 with a pinned connection 603. In other embodiments, the valve 601 may be supported by the housing 20 by a pinned connection (and may be a pivotable door or other types of valves discussed herein). The door 601 normally hangs vertically downward from the pinned connection as urged by the force of gravity due to the weight of the door. As can be understood with reference to FIG. 16, when the door 601 hangs vertically, the door 601 provides a barrier for discrete food products 700 disposed upon the upper surface of the wheel 240 to maintain the discrete food products 700 upon the upper surface of the wheel 240.

The door 601 is configured to readily rotate about the pinned connection 603 to allow discrete food products 700 to translate toward the receiving trough 260. In some embodiments, the door 601 is configured to rotate toward the open position (FIG. 17) when the wheel 240 rotates with some discrete food products 700 disposed upon the upper surface of the wheel 240, with the movement of the discrete food products, urged by rotation of the wheel 240, causing the discrete food products 700 to contact the door and impart a force upon the door 601 to rotate the door as shown in arrow Z (FIG. 17) about its connection with the shroud 259 (or other structure such as the housing 20). When the wheel 240 stops rotating, the discrete food products 700 are no longer urged to move with the wheel 240 and the force imparted upon the door 601 lessens, until a point where the gravitational force upon the door (urging the door 601 to return to the closed position) overcomes the force applied to the side surface of the door 601 to allow the door 601 to return to the closed position.

In some embodiments, the door 601 may be urged toward the closed position with a biasing member (shown schematically in FIGS. 16 and 17), such as a spring (helical spring mounted upon the pinned connection 603, or a linear spring disposed between the shroud 259 and the door 601 as schematically depicted). In this embodiment, the force of a spring 620 can be optimized based upon the volume of the smallest portion of discrete food products 700 that is desired to be added to the receiving trough 260, such that the door 601 does not pivot to the open position until the force imparted upon door 601, based upon the combined weight of the discrete food products 700 acting upon the door, creates a torque upon the door 601 to overcome the biasing force of the spring 620. One of ordinary skill in the art with a thorough review of this specification will understand that the determination of the force imparted upon the door 601 (and the location of that force upon the door) for the smallest portion of the discrete food product can be understood with merely routine modeling and experimentation of the force/location upon the door 601 and therefore can select the appropriate biasing force necessary to achieve this desired result with only routine optimization which is well within the level of ordinary skill in the art.

In other embodiments, the valve 601 (whether a pivotable door or other structures, such as a moving gate) may be automatically controlled to be opened or closed depending upon the operational status of the wheel 240. For example, the valve 601 may be designed to be closed whenever the wheel 240 is not rotating, to prevent unwanted discrete food products from falling into the receiving trough 260. When the wheel 240 rotates (such as due to the operator providing an input to provide a quantity of discrete food products 700 to the receiving trough 260 for disbursement into a package), the valve 601 may additionally open to allow the discrete food products 700 to move from the wheel 240 to the receiving trough 260. In some embodiments, the timing of the operation of the valve 601 may be optimized to stay open for a discrete period of time after the wheel 240 stops rotating (such as 1, 5, or 10 seconds) to allow all of the discrete food products 700 that likely will fall from the wheel 240 to the receiving trough 260 to do so to avoid the valve 601 cutting, compressing, or otherwise damaging the discrete food products 700 (such as between the wheel 240 and the lower edge 602 of the valve 601) as the valve 601 is urged to its closed position. The valve 601 may be automatically controlled by a dedicated motor or linear actuator, solenoid or the like, or may receive a motive force, either directly or through a transmission, from the motor that controls the wheel 240.

The wheel 240 may also be mounted with respect to the shroud 259 (discussed below) or a side wall of the housing to allow clearance of the ribs 249 of the wheel 240 as the wheel rotates, but is positioned close enough to the shroud 259 (when provided) or the side wall to prevent discrete food items (shown schematically as 704) to fall therebetween.

The wheel 240 may be rotated directly by a motor (not shown, but conventional) or ultimately by a motor via a transmission. The motor may be in electrical communication with a controller 420 (discussed below) such that the wheel 240 rotates when called for by the controller based upon the functionality discussed below.

In some embodiments a shroud 259 may be provided that surrounds a portion of the wheel 240 and specifically an outer circumference of the wheel 240 proximate to the wheel (after a position on the wheel where a food item falls from the wheel (as schematically shown in FIG. 14 as item 703) and one or both side surfaces of the wheel 240. As discussed above, the shroud 259 may be positioned to prevent food items (704) from falling out of the hopper 220.

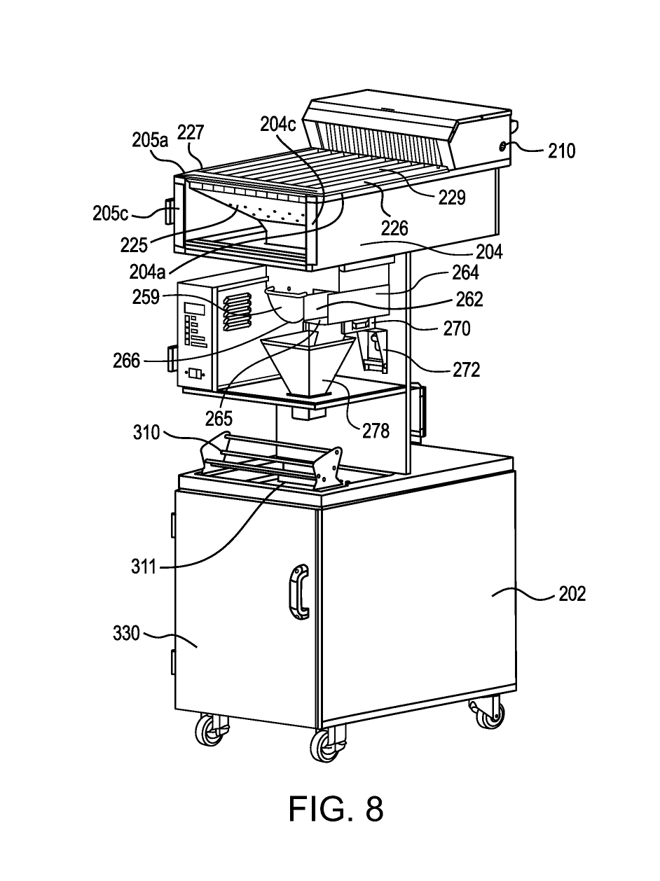

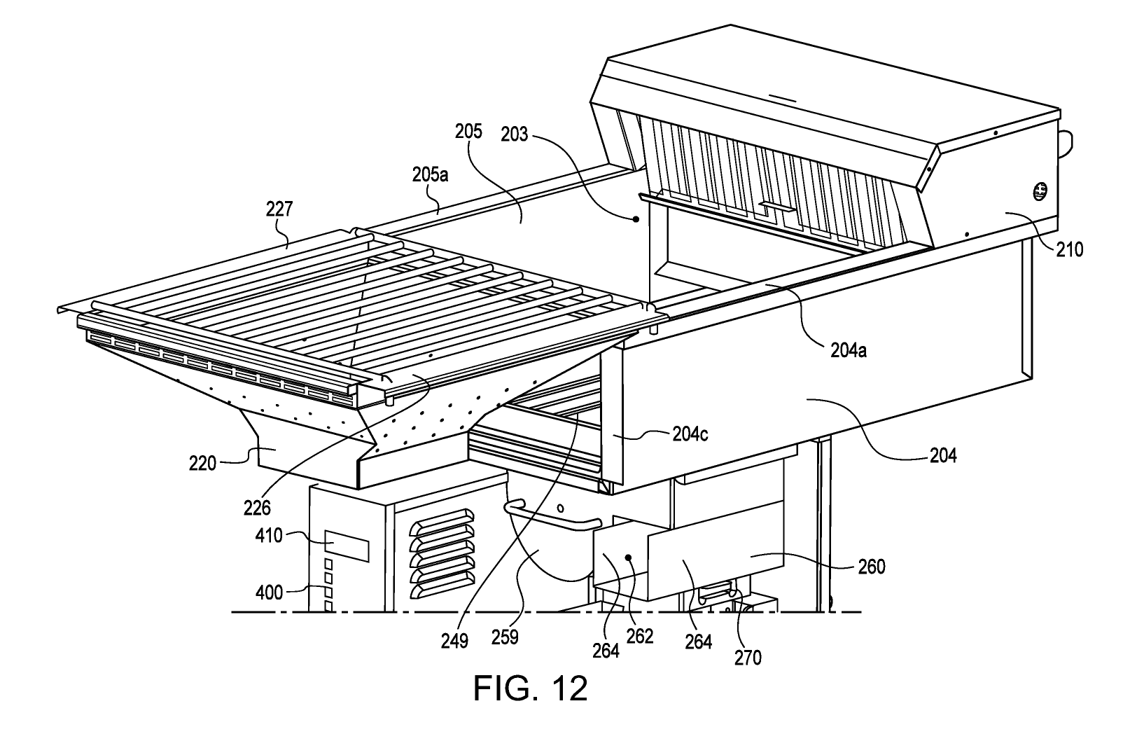

The shroud 259 may be retained by the housing 202, such as a side wall 204, 205 of the housing. The shroud 259 may be slidably mounted to be movable from a normal enclosing position (FIG. 8) where the shroud 259 closely encloses the wheel 240 to a removed position (FIG. 13) where the shroud 259 is pulled away from the wheel 240. The shroud 259 may be slid to the removed position for cleaning (such as to remove crumbs from under the wheel) or for maintenance. In some embodiments the shroud slides upon a track 209 in the housing 202, while in other embodiments the shroud may extend from the hopper (and slide with or independently of the hopper 220). In some embodiments, the shroud 259 is fixed in the normal enclosing position when the front barrier 340 is in the normal closed position (such as the door being closed) and the shroud is slidable away from the wheel 240 when the front barrier is removed (e.g. the door opened).

A receiving trough 260 may be pivotably mounted upon the housing 202 and positioned such that an open volume 262 of the receiving trough receives discrete food pieces from the wheel 240, and specifically, discrete food pieces 703 that have passed by the side edge 238 of the hopper 220. As shown in FIG. 14, the discrete food pieces may fall into the open volume 262 by gravity (depicted as 703 falling vertically downward in the direction Y), and in some embodiments, a slide may be provided to urge the discrete food pieces horizontally as urged by gravity.

The receiving trough 260 may be an elongate U-shaped member that includes side walls 264 and a bottom wall 265 that collectively form the open volume 262. The walls extend to an extended end 266. A rear plate 267 may be provided that encloses the open volume at the rear end of the receiving trough 260 (i.e. the end opposite from the extended end 266).

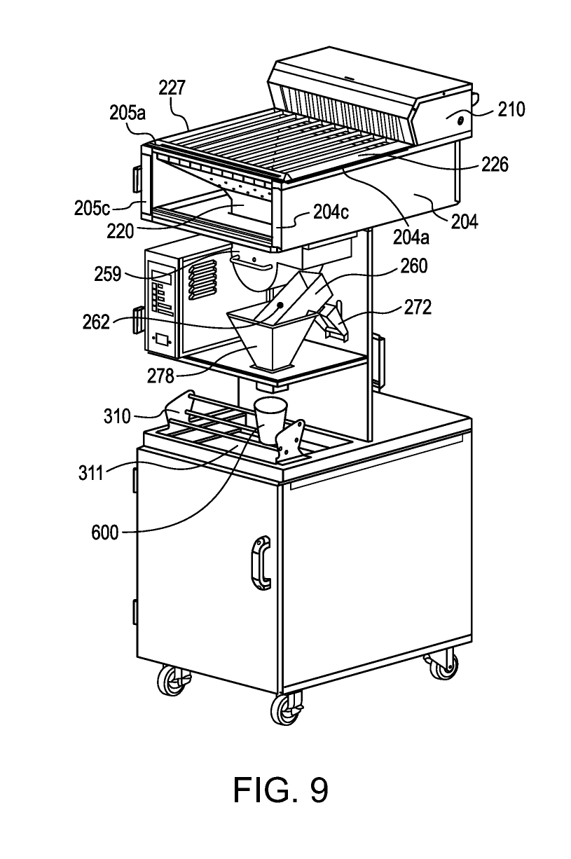

The receiving trough 260 may be pivotable from a receiving position (FIG. 8) where the open volume 262 is aligned horizontally (or at a slight orientation where the extended end 266 is above the opposite rear end) and a dispensing position (FIG. 9) where the extended end 266 is positioned below the rear end. The receiving trough is configured such that, when the receiving position, the discrete food items delivered to the receiving trough from the wheel are maintained within the receiving trough for storage therein, and when the receiving trough is pivoted to the dispensing position, the discrete food items slide along the receiving trough toward the extended end 266 and are able to fall out of the receiving trough due to gravity.

The receiving trough 260 may be pivotably mounted to the housing with a transmission 272 that causes the receiving trough to pivot back and forth between the receiving and dispensing positions and be selectively maintained in either position. In some embodiments, a motor, such as a stepper motor, may be operatively connected to the receiving trough through the transmission 272. Alternatively, a motor may be connected to the receiving trough 260 with a transmission that is configured such that one rotation of the motor causes the receiving trough 260 to rotate from the receiving position, to the dispensing position, and return to the receiving position. One of ordinary skill would understand that there are numerous ways known in the art to provide for repeatable forced pivoting motion of the receiving trough 260 with a transmission and all of known transmissions are specifically within the scope of this disclosure and contemplated herein.

In some embodiments, the receiving trough 260 may include a scale 270 that measures the weight of items that are disposed within the open volume 262 of the receiving trough. In some embodiments, the scale 270 may be configured to measure the steady state weight of the items that are disposed within the open volume 262 (i.e. the scale neglects any effects of the impact force of the items falling onto the receiving trough 260, such as measuring the weight 1, 2, 4 seconds (or another suitable delay time) after the scale initially detects an increased weight (due to the first food item falling onto the receiving trough 260 from the wheel). Alternatively, the steady state weight may be calculated by controlling for the average weight felt by the scale during impact of the typical food product used with the system as determined during the calibration process. In some embodiments, the scale 270 is a load cell.

A funnel 278 may be disposed below the receiving trough 260 and specifically to receive food product from the extended end 266 of the receiving trough 260 when in the dispensing position. The funnel 278 may have a decreasing internal cross-section along its length to reposition or organize the discrete food items into a usable and/or consistent arrangement as the food product falls through the funnel, such that the food product is oriented to enter a food container 600 to effectively and repeatedly fill the container.

The housing 202 may further include a rack 310 that is fixed below the funnel 278 and is configured to support a food container, such that when the container is aligned upon the rack 310 and below the funnel, discrete food items that are moved by the food distribution and metering system are directed into the food container 600. The rack 310 may be sized to support several food containers, such that containers can be prepared for filling and placed upon the rack (but now below the funnel 278) in advance of use, and that containers that have been filled with food can be moved to another portion of the rack (away from the funnel so that another container can be filled) before they are served to the customer.

As discussed above, the housing 202 may enclose and support an input 400 and/or a display 410. The input 400 and display 410 may be positioned to be easily manipulated and visualized by the user, such as upon the front of the housing. In some embodiments, the removable portion (such as the door 340) may include an aperture (340a, FIG. 7) that allows the display 400 and input to be accessible therethrough.

The input 400 may include one or more of a plurality of buttons, a touchscreen, a dial or other input devices to allow the user to communicate the desired operation of the device 200. For example, in embodiments where the device 200 is configured to apply a metered volume of discrete food products, such as a specific volume of French Fries, or a specific number of chicken nuggets, the input allows the user to select the specific volume or amount desired. For example, the input may allow the select between “small,” “medium,” or “large” French Fries, or a specific number of chicken nuggets or a similar volume or amount of discrete food products that are cooked and stored in a relatively large volume but sold in smaller volumes. The input may also allow the user to select manual, which would cause the food to be dispensed for a specified amount of time, or for the amount of time that the manual input is depressed.

While the embodiments disclosed here contemplate that the user will directly interact with the input upon the housing 202, the system may also be operable with a remote input system, such as a central control, a specific control (such as a tablet or a smart phone), a cash register, or the like. These remote inputs may communicate with the controller 420 (located within the housing and depicted schematically as 420) through a wired connection, or over a wireless connection such as Wi-Fi, Bluetooth, or the like. In some embodiments, the system 200 could be used for a customer to use, such as in situations where a restaurant offered “bottomless” fries or other self-service options, such as in a cafeteria setting.

The input 400 may communicate with the controller 420, and specifically communicate the user's selected volume or number of discrete food items (or “manual” as discussed above). Upon receipt of the selection from the input, the user signals the wheel 240 to begin rotating in the direction Q or allows the wheel to rotate. The controller 420 also compares the input selected with a menu that is stored in the controller, with the menu providing the weight of the food product (within the trough 260) based upon the selection. As the wheel 240 rotates, discrete items of food product are urged from the hopper 220 and entrained along the wheel 240 and with continued rotation of the wheel 240 food items fall into the receiving trough 260. The scale 270 of the receiving trough 260 measures the weight of the food product received by the receiving trough and sends a signal that corresponds to the weight (and in some embodiments, the steady state measured weight) to the controller. The controller 420 compares the weight signal from the scale with the programmed weight based upon the user's selection. While the measured weight is less than the programmed weight the controller continues to allow the wheel to rotate, and when the measured weight is equal to or exceeds (collectively corresponds) the programmed weight the controller stops (or sends a signal to stop) the rotation of the wheel 240.

Upon stopping the rotation of the wheel 240, the controller causes the receiving trough 260 to pivot toward the dispensing position, and maintain the receiving trough in the dispensing position for a small delay (such as 1-2 seconds) to allow the discrete food product to slide upon the bottom surface 265 and over the extended end 266, which causes the food product to fall by gravity through the funnel 278 and to the rack 310 (where the user had previously positioned an empty food container 600 that corresponds with the size of the food container entered into the input 400 (or the number of discrete food items entered)). The controller 420 then waits for the next signal from the input 400. The display 410 is operated by the controller 420 to provide user prompts and status updates.

While the preferred embodiments of the disclosure have been described, it should be understood that the disclosure is not so limited and modifications may be made without departing from the invention. The scope of the invention is defined by the appended claims, and all devices that come within the meaning of the claims, either literally or by equivalence, are intended to be embraced therein.

1. A food storage and metered distribution system, comprising:
a housing comprising an open top, and opposite first and second side walls that define a portion of the open top and an internal volume therebetween, the housing further comprises a front barrier that when positioned establishes a portion of the internal volume and when removed allows for access into the internal volume,
a hopper disposed within the housing comprising a storage volume and an open bottom;
a food distribution and metering system disposed within the housing comprising a wheel disposed below the open bottom of the hopper and a receiving trough disposed below the wheel,
wherein the hopper is slidably mounted upon upper portions of the first and second side walls such that the hopper can slide with respect to the first and second side walls when the front barrier is removed to an extended position and returned to a normal position where the hopper is disposed such that its open bottom is above the wheel.

2. The food storage and metered distribution system of claim 1, wherein the hopper comprises first and second flanges that extend outward from the hopper, wherein the first and second flanges engage the respective first and second side walls to allow the hopper to slide with respect to the housing.

3. The food storage and metered distribution system of claim 2, wherein the first and second flanges slide within respective tracks supported by the first and second side walls.

4. The food storage and metered distribution system of claim 1, further comprising a mechanical compartment that is supported by the housing, the mechanical compartment comprises at least one heating element and a fan to direct heated air through the hopper when the hopper is in the normal position.

5. The food storage and metered distribution system of claim 1, further comprising an input device disposed within the compartment, wherein the wheel is configured to begin rotating toward the receiving trough upon receipt of an input by the input device.

6. The food storage and metered distribution system of claim 5, wherein the input received by the input device is the volume of a food storage container that is desired to be filled by food product from within the housing.

7. The food storage and metered distribution system of claim 6, wherein the receiving trough includes a scale that is configured to measure a weight of items disposed within the trough.

8. The food storage and metered distribution system of claim 7, wherein the scale is configured to measure the steady state weight of items disposed within the trough.

9. The food storage and metered distribution system of claim 1, wherein the receiving trough is pivotably mounted to the housing, wherein the receiving trough is normally in a receiving position wherein discrete food items delivered to the receiving trough from the wheel are maintained within the receiving trough, and the receiving trough is pivotable to a dispensing position where the discrete food items disposed within the receiving trough fall from the receiving trough due to gravity.

10. The food storage and metered distribution system of claim 7, wherein the receiving trough is pivoted to the dispensing position when a measured weight by the scale corresponds to a weight upon the receiving trough that is representative of the volume of the food storage container that is desired to be filled by from the food product.

11. The food storage and metered distribution system of claim 10, wherein the wheel stops rotating when the measured weight by the scale corresponds to a weight upon the receiving trough that is representative of the volume of the food storage container that is desired to be filed by the food product.

12. The food storage and metered distribution system of claim 1, further comprising a shroud that is slidably disposed within the housing, wherein the shroud surrounds a bottom portion of an outer surface of the wheel, wherein the shroud can be slid between an enclosing position where the shroud is proximate to the wheel and a removed position where the shroud is pulled away from the wheel, allowing access to the inner surface of the shroud.

13. The food storage and metered distribution system of claim 1, wherein the front barrier is a door that is hingedly mounted upon an edge of the first wall, wherein when the door is positioned the door seals with front edges of both of the first and second wall to enclose the internal volume.

14. The food storage and metered distribution system of claim 1, the lower opening of the open bottom of the hopper is positioned, when the hopper is in the normal position, such that discrete food items that are placed within the storage volume of the hopper are urged toward and through the lower opening and onto a top circumference of the wheel.

15. The food storage and metered distribution system of claim 1, wherein the wheel comprises an outer circumferential surface and a plurality of ribs that extend radially outward therefrom, wherein each of the plurality of ribs extends from the wheel a distance such that each rib passes closely by each of opposite parallel edge of the hopper that defines the open bottom.

16. The food storage and metered distribution system of claim 9, further comprising a rack configured to retain a container for a food product in a position where the container receives discrete items of food product from the receiving trough when the receiving trough is in the dispensing position.

17. The food storage and metered distribution system of claim 16, wherein the housing further comprises a storage area disposed below the receiving trough and the rack, wherein discrete items of food product that fall from the receiving trough by miss the container for the food product disposed upon the rack fall to the storage area, wherein the housing further comprises a second door that selectively allows access to the storage area.

18. The food storage and metered distribution system of claim 12, wherein the shroud movably supports a valve that is positioned with respect to the wheel to block movement of the food product from the wheel to the receiving trough when in the closed position, and can be moved to an open position to allow movement of the food product from the wheel to the receiving trough when in the open position.

19. The food storage and metered distribution system of claim 18, wherein the valve is a door that is pivotably mounted to the shroud, wherein the door is urged to the closed position due to a gravitational force upon the door and wherein the door is pivotable to the open position.

20. The food storage and metered distribution system of claim 19, wherein the door is urged to the open position due to force imparted upon the door by food product disposed upon the wheel and moving with the wheel as the wheel rotates.

21. The food storage and metered distribution system of claim 20, wherein the closed position is an orientation of the door where the door hangs downwardly from a pinned connection with the shroud proximate to a top edge of the door.

22. The food storage and metered distribution system of claim 1, wherein the housing movably supports a valve that is positioned with respect to the wheel to block movement of food product from the wheel to the receiving trough as urged by rotation of wheel when in the closed position, and can be moved to an open position to allow movement of the food product from the wheel to the receiving trough when in the open position.

23. The food storage and metered distribution system of claim 1, further comprising a valve movably disposed proximate to the wheel, wherein the valve is normally in a closed position that blocks movement of food products from the wheel to the receiving trough.

24. The food storage and metered distribution system of claim 23, wherein the valve is a door that is pivotably mounted with respect to the housing.

25. The food storage and metered distribution system of claim 24, wherein the door pivotably mounted with a pinned connection and is urged to the closed position by the force of gravity and wherein the door is pivotable to an open position with the application of a force upon the door, wherein food products from the wheel have a path to travel to the receiving trough when the door is in the open position.

26. The food storage and metered distribution system of claim 23, wherein the valve is biased toward the closed position with a spring.

27. The food storage and metered distribution system of claim 25, wherein the door is urged toward the open position due to a force imparted upon the door by food product disposed upon the wheel and contacting a side surface of the door as the food product moves as urged by rotation of the wheel.
